(19) United States
(12) Patent Application Publication
(10) Pub. No.: US 2006/0219986 A1
(43) Pub. Date: Oct. 5, 2006

(54) Mixed conductive carbon and electrode

(75) Inventors: Hiroshi Yokota, Kanagawa (JP); Masashi Shimoyama, Kanagawa (JP); Eiichi Akiyama, Kanagawa (JP); Kazuyoshi Takeda, Kanagawa (JP)

Correspondence Address: BROWDY AND NEIMARK, P.L.L.C.;624 NINTH STREET, NW, SUITE 300, WASHINGTON, DC, 20001-5303, US

(73) Assignee: EBARA CORPORATION, TOKYO (JP)

(21) Appl. No.: 10/546,200

(22) PCT Filed: Feb. 24, 2004
(86) PCT No.: PCT/JP04/02143

§ 371 Date: Apr. 13, 2006

(30) Foreign Application Priority Data
Feb. 25, 2003 (JP) 2003-046987

(51) Int. Cl. H01B 1/24; H01M 4/88; H01M 4/96

(52) U.S. Cl. 252/510; 429/42; 429/40; 502/101

(57) ABSTRACT

An electrode having both of electronic conductivity and ionic conductivity is provided. An electrode provided with a mixed conductive carbon having electronic conductivity and ionic conductivity, the carbon containing an ion-dissociative group on the surface thereof. The use of a platelet-type or herringbone-type carbon fiber as the carbon material enables the introduction of ion-dissociative groups at a high density with continuity, whereby ion paths are effectively formed and an excellent ionic conductivity can be imparted, in addition to the electron conductivity inherent in the carbon fiber.

### TECHNICAL FIELD

The present invention relates to a carbon having both of electronic conductivity and ionic conductivity, and a method for preparing the same. Furthermore, the present invention relates to an electrode using the carbon.

### BACKGROUND OF THE INVENTION

Since a graphitized carbon has a high chemical stability and exhibits a good electronic conductivity, it has widely been used as an electrode and the like. In particular, owing to the large specific surface area, carbon black powder can provide an increased electrode area and is also effective as a catalyst support, so that it has widely been utilized as a part of an electrode. Moreover, a carbon nano-tube is known to exhibit conductivity similar to a metal or a semiconductor thanks to its structure. Particularly, with regard to a carbon nano-horn, which is one kind of carbon nano-tubes, since its aggregated structure is effective for dispersion of a catalyst, it is reported that the carbon nano-horn is more effective as an electrode material than carbon black.

However, these materials only utilizes the conductivity of a carbon itself and a carbon having both of electronic conductivity and ionic conductivity has hitherto not been prepared.

Recently, with regard to fullerene, which is a cage-like molecule of a carbon, it is reported that the introduction of a proton-dissociative group onto its surface achieves protonic conductivity as an aggregate (Japanese Patent Laid-Open No. 63918/2002). However, the material only exhibits characteristics as a protonic conductor but hardly exhibits electronic conductivity, so that it cannot be used as an electrode by itself.

More recently, it is proposed that a monomer as a starting material for an electrolyte polymer is graft-polymerized onto the surface of carbon black to impart protonic conductivity to the surface (Autumn Meeting of Electrochemical Society of Japan, 2002, Abstract, p. 85). However, since edges of graphene are irregularly present on the surface of carbon black, a proton-dissociative group cannot be introduced at a high density, so that both of protonic conductivity and electronic conductivity are regarded to be unsatisfactory owing to the insufficient connectivity. Furthermore, a carbon having hydroxyl ion-conductivity has hitherto not been reported.

### DISCLOSURE OF THE INVENTION

The present invention provides a carbon having both of electronic conductivity and ionic conductivity and a method for preparing the same, and an electrode provided with the carbon.

The present inventors have found that the above problems can be solved by introducing an ion-dissociative group into a carbon material, and thus have accomplished the invention.

Namely, the invention related to a mixed conductive carbon having electronic conductivity and ionic conductivity, comprising an ion-dissociative group on the surface of a carbon material.

Moreover, the invention relates to an electrode provided with the above mixed conductive carbon.

Furthermore, the invention relates to a method for preparing a mixed conductive carbon comprising a step of treating a carbon material in sulfuric anhydride or fuming sulfuric acid to introduce a sulfonic acid group.

In addition, the invention relates to a method for preparing a mixed conductive carbon comprising a step of subjecting the surface of a carbon material to an oxidation treatment and a subsequent step of reacting the surface with a molecule having a proton-dissociative group or a hydroxyl ion-dissociative group.

### BRIEF DESCRIPTION OF THE DRAWINGS

FIG. 1 is a schematic view of platelet-type and herringbone-type carbon fibers.

FIG. 2 is a schematic view of a mixed conductive carbon of protons and electrons.

FIG. 3 is a schematic view of a mixed conductive carbon of hydroxyl ions and electrons.

FIG. 4 is a schematic view of a mixed conductive carbon fiber electrode on which a catalyst is supported.

### BEST MODE FOR CARRYING OUT THE INVENTION

In the present invention, mixed conductive properties mean that both of electronic conductivity and ionic conductivity are present.

The carbon material for use in the invention is not particularly limited as far as it exhibits electron conductivity, but a carbon fiber is preferred from the viewpoint that ion-dissociative groups can be introduced at a high density. Since a carbon fiber having smaller diameter has an increased specific surface area and thus a relative ratio of ionic conductivity increases, the fiber having small diameter is preferred in view of enhancing ionic conductivity. Specifically, the diameter of the carbon fiber may be, for example, 5 to 1,000 nm, preferably 10 to 500 nm, more preferably 30 to 100 nm. The length of the carbon fiber is not particularly limited and can be suitably determined depending on the purpose of the mixed conductive carbon and electrode to be needed. Usually, the length of the carbon fiber is, in general, 1 to 100 μm.

Moreover, a carbon material whose graphene edges are exposed on the surface side by side is preferred from the viewpoint that the ion-dissociative groups can be introduced with continuity. As the examples of such a carbon material, a platelet-type or herringbone-type carbon fiber can be mentioned, as shown in FIG. 1. The use of a platelet-type or herringbone-type carbon fiber enables the introduction of ion-dissociative groups at a high density with continuity, whereby ion paths are effectively formed and an excellent ionic conductivity can be imparted, in addition to the electron conductivity inherent in the carbon fiber.

The ion-dissociative group for use in the invention is not particularly limited as far as it dissociates an ion. For example, any proton-dissociative groups can be used for imparting proton-conductivity, and any cation-conductive groups can be used for imparting cation-conductivity. Similarly, any hydroxyl ion-dissociative groups can be used for imparting hydroxyl ion-conductivity, and any anion-conductive groups can be used for imparting anion-conductivity.

Examples of the proton-dissociative group include —OH, —SO₃H, —COOH, —OSO₃H and —OPO(OH)₃.

By substituting the above proton with the other cation, a mixed conductive carbon having each cation-conductive group can be obtained.

Moreover, as the hydroxyl ion-dissociative group, any of ammonium hydroxide derivatives, pyridinium hydroxide derivatives and imidazolium hydroxide derivatives can be used and examples thereof include —N⁺(CₙH₂ₙ₊₁)₃OH⁻ and —N⁺C₅H₅OH⁻, wherein n represents an integer of 1 to 3.

By substituting the above hydroxyl ion with the other anion, a mixed conductive carbon having each anion-conductive group can be obtained.

These ion-dissociative groups may be directly bonded to graphene or may be bonded to graphene through any binding group.

As the method for preparing the mixed conductive carbon of the invention, a usual method for introducing a functional group onto a carbon surface can be used.

For example, in order to bond a sulfonic acid group directly to graphene, a carbon material is treated in sulfuric anhydride or fuming sulfuric acid. In the case that a sulfonic acid group is directly bonded to graphene, a carbon having an excellent proton-conductivity can be obtained because the sulfonic acid group is an acidic group having a large degree of dissociation.

Moreover, in order to bond a hydroxyl group or a carboxyl group directly to graphene, for example, a carbon material is subjected to an oxidation treatment with a sulfuric acid solution of ammonium peroxide.

Furthermore, in order to bond an ion-dissociative group to graphene through a binding group, a carbon material is subjected to an oxidation treatment to introduce a hydroxyl group or a carboxyl group and subsequently the hydroxyl group or the carboxyl group is reacted with a molecule having an ion-dissociative group.

For example, in order to introduce a sulfonic acid group having a binding group, a carbon to which a hydroxyl group or a carboxyl group has been introduced beforehand is reacted with a sulfonic acid having a binding group, such as acrylamidomethylpropaneslfonic acid.

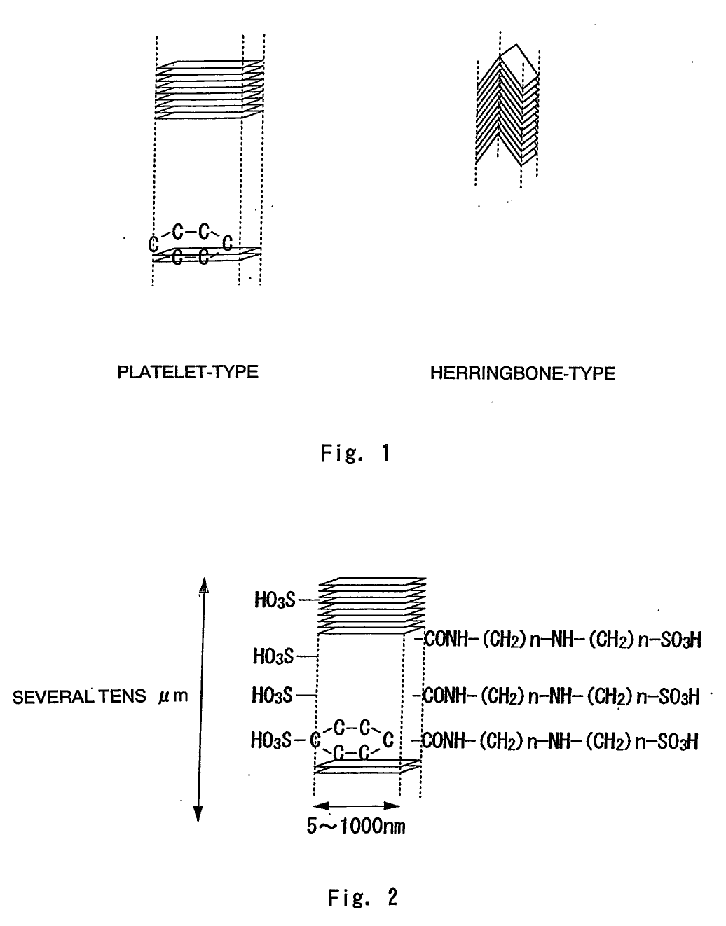

FIG. 2 shows an example of the mixed conductive carbon having a proton-dissociative group.

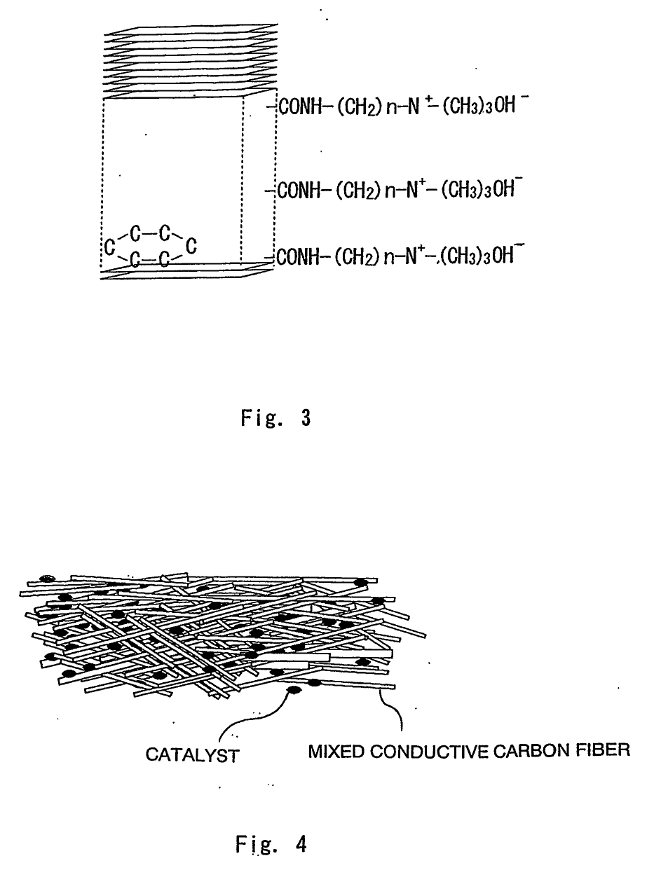

On the other hand, in order to introduce a hydroxyl ion-dissociative group to a carbon material, for example, a carbon to which a carboxyl group has been introduced is mixed with an amine compound such as dimethylaminopropylamine (H₂N(CH₂)₃N(CH₃)₂) to convert the carboxyl group into an amide and then the resulting product is reacted with methyl iodide (CH₃I) to form an ammonium iodide, i.e., a trimethylammonium iodide, which is subjected to an alkali treatment to form a hydroxide. FIG. 3 shows an example of the mixed conductive carbon having a hydroxyl ion-dissociative group.

In the case that an ion-dissociative group is introduced to a carbon fiber, the introduction may be carried out in a dispersed state of the carbon fiber or in a state after the carbon fiber has been molded. The carbon fiber to which an ion-dissociative group is introduced has electron-conductivity together with ion-conductivity even as a single fiber, but it is usually used as a molded article.

In this connection, a carbon to which an ion-dissociative group is introduced at higher density exhibits larger ion conductivity. Also, proton- or hydroxyl ion-conductivity is increased by moistening the fiber with steam.

By using the mixed conductive carbon of the invention as an electrode, an electrode excellent in electronic conductivity and ionic conductivity can be obtained. In addition, since a carbon material usually has a low solubility in a solvent and exhibits a sufficient resistance to a temperature of 100° C. or higher, there is an advantage that the material is hardly deteriorated when used as an electrode.

The use of a carbon fiber as a carbon material enables the formation of an electrode having further enhanced electronic conductivity and ionic conductivity because of good mutual connectivity owing to the fiber form. Furthermore, the use of the carbon fiber results in an excellent electrode exhibiting a rapid mass transfer and a low reaction resistivity since the specific surface area is large and voids are effectively maintained.

The electrode of the invention can be prepared by molding a mixed conductive carbon. The molding can be effected by a usual method and, for example, carbon fiber can be molded into a film form or a pellet form.

Moreover, it is also possible to prepare an electrode having an enhanced binding ability to an electrolyte by mixing the mixed conductive carbon and the other electrolyte material and molding the mixture.

Furthermore, the electrode of the invention can be also prepared by dispersing the mixed conductive carbon into a solvent and applying the dispersion onto an electrolyte film or the other electrode.

In addition, a catalyst may be supported on the electrode of the invention. The catalyst can be supported by molding the mixed conductive carbon fiber into a sheet form and then supporting a catalyst thereon or by adding a catalyst into a solvent in which the mixed conductive carbon has been dispersed and then applying the catalyst-added dispersion onto an electrolyte film or the other electrode. FIG. 4 shows an example of the electrode on which a catalyst is supported.

### EXAMPLES

The following will describe the present invention with reference to Examples but Examples are only presented for the purpose of assisting the understanding of the invention and thus the invention is not limited to the following Examples.

### Example 1

About 0.5 g of a herringbone-type carbon fiber having a diameter of about 40 nm was immersed in a sulfuric acid solution of 0.6N ammonium persulfate, followed by 3 hours of the treatment at 70° C. Thereafter, the carbon fiber was separated by filtration and washed with water to obtain a mixed conductive carbon. Then, the resulting mixed conductive carbon was molded into a film form, whereby an electrode was produced.

Water was added dropwise to the resulting electrode and acidity was confirmed with litmus paper to confirm the presence of proton.

Also, the presence of a carboxyl group was confirmed by infrared absorption analysis.

Then, on the resulting electrode, sheet resistance was measured by four-terminal direct current method and impedance measurement was carried out by the two-terminal alternative current method, to evaluate electronic conductivity and ionic conductivity.

In the atmospheric air at room temperature, electronic conductivity was about 2 Scm⁻¹ and ionic conductivity was about 10⁻⁸ Scm⁻¹.

### Example 2

About 0.5 g of a herringbone-type carbon fiber having a diameter of about 40 nm was placed in a reaction flask and fuming sulfuric acid was added thereto, followed by 10 hours of the treatment at 55° C. under N₂. Thereafter, the carbon fiber was separated by filtration and washed with water to obtain a mixed conductive carbon. Then, the resulting mixed conductive carbon was molded into a film form, whereby an electrode was produced.

Absorptions of the bonds of C—S and O—SO₂—O were observed on infrared absorption analysis of the resulting electrode and hence the presence of sulfonic acid groups such as C—SO₃H and C—O—SO₃H was confirmed.

Also, on the resulting electrode, sheet resistance measurement and impedance measurement were carried out as in Example 1.

Electronic conductivity was about 1 Scm⁻¹ and ionic conductivity was about 1⁻⁴ Scm⁻¹. When water was added dropwise to the electrode, only ionic conductivity was increased to 2×10⁻³ Scm⁻¹.

### Example 3

On the carbon fiber prepared in Example 1 to which a carboxyl group had been introduced, the carboxyl group part was reacted with dimethylaminopropylamine (H₂N(CH₂)₃N(CH₃)₂) and then the product was reacted with methyl iodide (CH₃I) to form a trimethylammonium iodide. Then, it was converted into a hydroxide by an alkali-treatment, and the product was washed with water, filtrated and dried to obtain a mixed conductive carbon when the mixed conductive carbon was dispersed in water, the dispersion water showed a strong alkalinity.

The resulting mixed conductive carbon was molded into pellets, whereby an electrode was produced.

On the resulting electrode, sheet resistance measurement and impedance measurement were carried out as in Example 1. Electronic conductivity was about 1.0 Scm⁻¹ and hydroxyl ionic conductivity was about 10⁻⁵ Scm⁻¹.

### INDUSTRIAL APPLICABILITY

According to the present invention, a carbon having both of electronic conductivity and ionic conductivity can be obtained. Moreover, an electrode provided with the carbon exhibits resistances to solvents and temperature.

1. A mixed conductive carbon having electronic conductivity and ionic conductivity, comprising an ion-dissociative group on the surface of a carbon material.

2. The mixed conductive carbon according to claim 1, wherein the carbon material is a carbon fiber.

3. The mixed conductive carbon according to claim 2, wherein the diameter of the carbon fiber is in a range of 5 to 1,000 nm.

4. The mixed conductive carbon according to claim 2, wherein the carbon fiber is a platelet-type or herringbone-type carbon fiber.

5. The mixed conductive carbon according to claim 1, wherein the ion-dissociative group is directly bonded to graphene constituting the carbon material.

6. The mixed conductive carbon according to claim 1, wherein the ion-dissociative group is bonded to graphene through a binding group.

7. The mixed conductive carbon according to claim 1, wherein the ion-dissociative group is a proton-dissociative group.

8. The mixed conductive carbon according to claim 7, wherein the proton-dissociative group is selected from the group consisting of —OH, —SO₃H, —COOH, —OSO₃H and —OPO(OH)₃.

9. The mixed conductive carbon according to claim 1, wherein the ion-dissociative group is a hydroxyl ion-dissociative group.

10. The mixed conductive carbon according to claim 9, wherein the hydroxyl ion-dissociative group is selected from the group consisting of ammonium hydroxide derivatives, pyridinium hydroxide derivatives and imidazolium hydroxide derivatives.

11. An electrode provided with the mixed conductive carbon according to claim 1.

12. A method for preparing a mixed conductive carbon, comprising a step of treating a carbon material in sulfuric anhydride or fuming sulfuric acid to introduce a sulfonic acid group thereinto.

13. A method for preparing a mixed conductive carbon, comprising a step of subjecting the surface of a carbon material to an oxidation treatment, and a step of reacting the surface with a molecule having a proton-dissociative group or a hydroxyl ion-dissociative group.

14. The method according to claim 12, wherein the carbon material is a carbon fiber.
